(19) United States
(12) Patent Application Publication
(10) Pub. No.: US 2014/0159334 A1
(43) Pub. Date: Jun. 12, 2014

(54) TORSION BEAM FOR SUSPENSION IN VEHICLE

(71) Applicant: Hyundai Motor Company, Seoul (KR)

(72) Inventors: Dae Won Jang, Yongin (KR); Sung Bae Jang, Suwon (KR); Hee Gon Kang, Anyang (KR)

(21) Appl. No.: 13/830,058

(22) Filed: Mar. 14, 2013

(30) Foreign Application Priority Data
Dec. 7, 2012 (KR) 10-2012-0141658

(51) Int. Cl. B60G 11/18

(52) U.S. Cl. CPC B60G 11/183
USPC 280/124.166

(57) ABSTRACT

A torsion beam for a suspension in a vehicle and a body member defining an outer shape is made of carbon fiber reinforcing plastic that is an advanced composite, so the weight can be reduced, and thus the torsion beam can be used for environment-friendly vehicles.

### CROSS-REFERENCE TO RELATED APPLICATION

This application claims under 35 U.S.C. §119(a) the benefit of Korean Patent Application No. 10-2012-0141658 filed Dec. 7, 2012, the entire contents of which are incorporated herein by reference.

### BACKGROUND

(a) Technical Field

The present invention relates to a torsion beam for a suspension in a vehicle, and more particularly, to a torsion beam for a suspension in a vehicle which is made of CFRP (Carbon Fiber Reinforced Plastic).

(b) Background Art

In general, the suspension of a vehicle is a part that prevents damage to the vehicle body or freight and improves ride comfort by preventing vibration or shock from being directly transmitted to the vehicle body from a road surface during vehicle operation.

A rear suspension that is typically used for the rear wheels of compact and middle-sized vehicles as a torsion beam axle type of vehicle suspensions, as shown in FIG. 1, includes a pair of trailing arms 1 arranged at the left and right sides of a vehicle body in the front-rear direction and a torsion beam 2 arranged in the left-right direction of the vehicle body, with both ends connected to the pair of trailing arms 1. The torsion beam 2 is typically made of steel to secure rigidity, having an open cross-sectional structure that opens downward.

A spring seat 3 and a spindle brocket 4 are coupled to the rear end of the trailing arm 1, the lower end of a coil spring 5 connected with the vehicle body 3 is seated in the spring seat 3, and the lower end of a shock absorber 6 connected with the vehicle body is disposed at a side of the coil spring 5. Further, a trailing arm bush 7 is fitted to the front end of the trailing arm 1 and combined with a bush bracket 9 by a bush shaft 8 and the bush bracket 9 is coupled to the vehicle body.

According to the rear suspension with the configuration described above, when a shock is transmitted from a road surface in vehicle operation, a tire on a wheel connected to the spindle bracket 4, the coil spring 5, and the shock absorber 6 absorbs the shock and minimizes transmission of vibrations to the vehicle body, so ride comfort is improved. Further, the torsion beam 2 improves roll stiffness and lateral stiffness by means of torsional elastic force.

However, since the torsion beam 2 of the related art is entirely made of steel to secure strength and durability, the structure is heavy and cannot contribute to weight reduction, which is important in improvement of fuel efficiency, and it is difficult to apply to environment-friendly vehicles.

The description provided above as a related art of the present invention is just for helping understanding the background of the present invention and should not be construed as being included in the related art known by those skilled in the art.

### SUMMARY OF THE DISCLOSURE

The present invention has been made in an effort to solve the problems associated with the related art and an object of the present invention is to provide a torsion beam for a suspension in a vehicle which is made of a composite material, carbon fiber reinforced plastic, to achieve high strength, high elasticity, and a small size in comparison to steel or aluminum, and to improve fuel efficiency and to be applied to environment-friendly vehicles.

In order to achieve the objects of the present invention, torsion beam for a suspension in a vehicle includes: a body member with closed cross-sectional spaces at a front end and a rear end arranged in the front to rear direction of the vehicle and a middle portion connecting the front and rear ends and protruding upward, respectively; and a filler filled in the closed cross-sectional spaces to maintain the shape of the body member and integrally combine with the body member. As such, the body member is made of carbon fiber reinforced plastic (CFRP).

The body member may be composed of a plurality of film sheets made of carbon fiber reinforced plastic in the form of film and may be completed by stacking the film sheets with a predetermined thickness. The body member may have a plurality of openings between the front end and the rear end of the beam such that the degree of torsional freedom can be secured against an external force.

The body member may be composed of a plurality of film sheets made of carbon fiber reinforced plastic in the form of film, and the film sheets may be stacked with different thicknesses due to differences in rigidity required for portions of the body member. As such, the filler may be a foaming material, which defines the shape of the body member while being foamed and formed by heat, and which is integrally formed with the body member to keep the shape of the body member while hardening after being completely foamed.

### BRIEF DESCRIPTION OF THE DRAWINGS

The above and other features of the present invention will now be described in detail with reference to certain exemplary embodiments thereof illustrated the accompanying drawings which are given hereinbelow by way of illustration only, and thus are not limitative of the present invention, and wherein:

FIG. 1 is a view illustrating a coupled torsion beam axle type of rear suspension of the related art; and

FIG. 2 is a view illustrating a torsion beam according to an exemplary embodiment of the present invention.

It should be understood that the appended drawings are not necessarily to scale, presenting a somewhat simplified representation of various preferred features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, combustion, plug-in hybrid electric vehicles, hydrogen-powered vehicles and other alternative fuel vehicles (e.g. fuels derived from resources other than petroleum).

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

A torsion beam for a suspension in a vehicle according to exemplary embodiments of the present invention is described hereafter in detail with reference to the accompanying drawings.

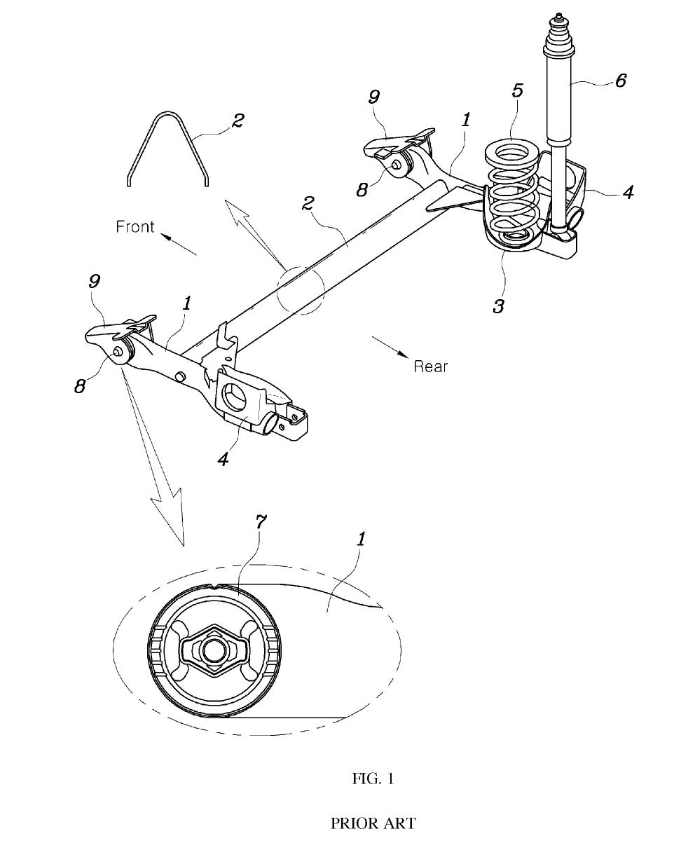

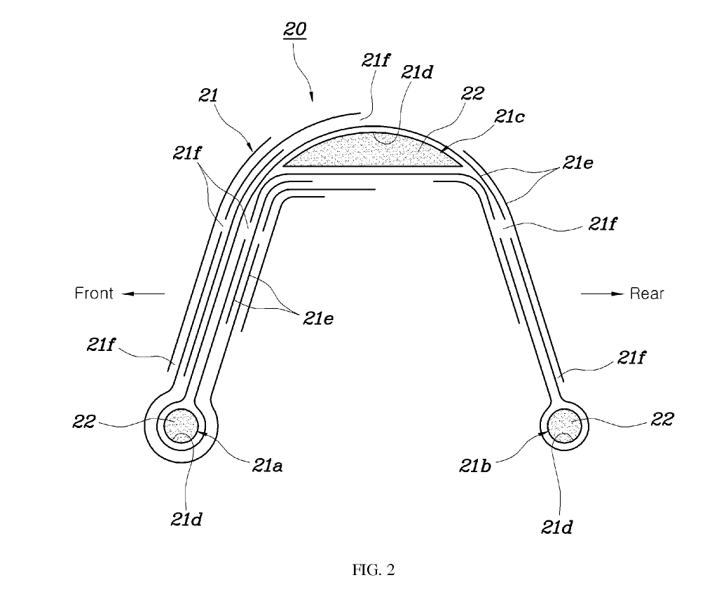

A torsion beam 20 for a suspension in a vehicle according to an exemplary embodiment of the present invention, in a cross-section taken in the front to rear direction of the vehicle as shown in FIG. 2, includes: a body member 21 with closed cross-sectional spaces 21d at the front end 21a and the rear end 21b arranged in the front-rear direction of the vehicle and a middle portion 21c connecting the front and rear ends 21a and 21b and protruding upward, respectively; and a filler 22 filled in the closed cross-sectional spaces 21d to maintain the shape of the body member 21 and integrally combined with the body member 21. Both ends of the torsion beam 20 in the left-right direction are integrally coupled to left and right trailing arm 1 arranged in the front-rear direction at the left and right sides of a vehicle body, respectively, as described with FIG. 1.

The body member 21 may be made of Carbon Fiber Reinforced Plastic (CFRP). The CFRP, a plastic-based composite that includes carbon fiber as a reinforcing material, has high strength, high elasticity, high durability, and high abrasion resistance, and is used for light structures, has excellent properties, and particularly, has excellent strength and elasticity and is light in comparison to steel and aluminum, so that it contributes to achieving light weight.

Therefore, when the body member 21 of the torsion beam 20 is made of CFRP, as in the present invention, it is possible to improve fuel efficiency of a vehicle by reducing the weight of the torsion beam 20, and accordingly, it is possible to use the torsion beam 20 according to the present invention for an environment-friendly vehicle of which the largest issue is weight reduction.

In detail, the body member 21 may be composed of a plurality of film sheets 21e made of CFRP in the form of a film and is completed by stacking the film sheets 21e with a predetermined thickness. The body member 21 of the torsion beam 20 may have a plurality of openings 21f between the front end 21a and the rear end 21b such that the degree of torsional freedom can be secured against an external force.

For example, a torsion force may be exerted in the body member 21 of the torsion beam 20, when pitching of the vehicle body is generated during vehicle operation or when a vehicle is turning, the roll stiffness and the lateral stiffness are reduced, and particularly, safety during vehicle operation is not secured, when the degree of freedom of the body member 21 against the torsion force is bad. The body member 21 of the torsion beam 20 may be configured to secure sufficient degree of torsional freedom, and the body member 21 of the torsion beam 20 according to an exemplary embodiment of the present invention may have the openings 21f to secure the degree of torsional freedom.

Further, the film sheets 21e may be stacked with different thicknesses due to differences in rigidity required for portions of the body member 21. That is, more and more film sheets 21e may be stacked to increase the thickness in, for example, the front portion of FIG. 2, at the portions requiring large rigidity. While less film sheets 21e may be stacked to a relatively thin thickness at the rear portion of FIG. 2, at the portions that do not require significant rigidity.

Therefore, the torsion beam 20 according to an exemplary embodiment of the present invention enables the body member 21 to maintain sufficient rigidity by adjusting the thicknesses of the film sheets 21e, achieving light weight by reducing the weight. Further, the filler 22 is a foaming material, which defines the shape of the body member 21 while being foamed and formed by heat, and which is integrally formed with the body member 21 to keep the shape of the body member 21 while hardening after completely foamed, and foaming materials such as rubber, vinyl, polyurethane, and styrofoam may be the filler.

As described above, since the body member 21 defining the outer shape of the torsion beam 20 according to an exemplary embodiment of the present invention is made of CRFP, which is an advanced composite, the strength, elasticity, durability, and abrasion resistance are high and weight is small in comparison to steel and aluminum, which are used in the related art, so that the weight can be reduced, and particularly, fuel efficiency of a vehicle can be improved by light weight, and accordingly the torsion beam can be used for environment-friendly vehicles.

According to a torsion beam for a suspension in a vehicle of the present invention, a body member defining the outer shape is made of CRFP, which is an advanced composite, so that the strength, elasticity, durability, and abrasion resistance are high and weight reduction therefore; the weight can be reduced, and particularly, fuel efficiency of a vehicle can be improved by reducing the weight, and accordingly the torsion beam can be used for environment-friendly vehicles.

The invention has been described in detail with reference to preferred embodiments thereof. However, it will be appreciated by those skilled in the art that changes may be made in these embodiments without departing from the principles and spirit of the invention, the scope of which is defined in the appended claims and their equivalents.

1. A torsion beam for a suspension in a vehicle, comprising:
a body member with closed cross-sectional spaces at a front end and a rear end arranged in a front to rear direction and a middle portion connecting the front and rear ends and protruding upward, respectively, wherein the body member is composed of a plurality of film sheets made of carbon fiber reinforced plastic in the form of film, and the film sheets are stacked with different thicknesses due to differences in rigidity required for various portions of the body member and wherein the body member is completed by completed by stacking the plurality of film sheets to a predetermined thickness; and
a filler filled in the closed cross-sectional spaces maintaining a shape of the body member and integrally combined with the body member.

2-3. (canceled)

4. The torsion beam for a suspension in a vehicle of claim 1, wherein the body member has a plurality of openings between the front end and the rear end such that a degree of torsional freedom is secured against an external force.

5. (canceled)

6. The torsion beam for a suspension in a vehicle of claim 1, wherein the filler is a foaming material, which defines the shape of the body member while being foamed and formed by heat, and which is integrally formed with the body member to maintain the shape of the body member while hardening after being completely foamed.
